(19) United States
(12) Patent Application Publication
(10) Pub. No.: US 2010/0030687 A1
(43) Pub. Date: Feb. 4, 2010

(54) Real-Time Settlement of Financial Transactions Using Electronic Fund Transfer Networks

(75) Inventors: Behram Panthaki, Garden City, NY (US); Jeremy N. Sokolic, New York, NY (US); Demetris Papademetriou, New York, NY (US); Amir Sunderji, San Jose, CA (US)

Correspondence Address: COURTNEY STANIFORD & GREGORY LLP, 10001 N. De Anza Blvd., Suite 300, Cupertino, CA, 95014, US

(73) Assignee: CASHEDGE, INC., New York, NY (US)

(21) Appl. No.: 12/357,308

(22) Filed: Jan. 21, 2009

Related U.S. Application Data
(60) Provisional application No. 61/022,104, filed on Jan. 18, 2008.

(51) Int. Cl. G06Q 40/00

(52) U.S. Cl. 705/43; 705/42

(57) ABSTRACT

Embodiments of a system for providing a financial management system to facilitate the transfer of funds among accounts held at different financial institutions and over different networks are described. The system performs a transaction involving a withdrawal of assets from a first account at a first financial institution and a deposit of at least a portion of the withdrawn assets to a second account at a second financial institution. The account user can select between real-time transactions and standard transactions. Real-time transactions are executed over an ATM network coupling the first financial institution and the second financial institution, and standard transactions are executed over an ACH network coupling the first financial institution and the second financial institution.

### CROSS-REFERENCE TO RELATED APPLICATIONS

The present application claims priority from provisional patent application No. 61/022,104, filed on Jan. 18, 2008, entitled “Real-Time Settlement of Financial Transactions Using Electronic Fund Transfer Networks”.

The present application is related to co-pending U.S. application Ser. No. 11/584,783 entitled “Multi-Channel Transaction System for Transferring Assets Between Accounts at Different Financial Institutions,” and filed on Oct. 19, 2006.

### FIELD

Embodiments of the invention relate generally to financial transaction computer networks, and more specifically, to a real-time credit and debit system for transferring funds between accounts at different financial institutions.

### BACKGROUND

Many present electronic funds transfer systems are based on the Automated Clearing House (ACH) network, which processes large volumes of both credit and debit transactions in accordance with rules and regulations established by industry associations (e.g., NACHA—National Automated Clearinghouse Association) and the United States Federal Reserve. ACH credit transfers include direct-deposit payroll payments and vendor payments; ACH debit transfers include mortgage and loan payment, insurance premium payments, bill payments, and so on. Many businesses are increasingly adopting ACH payments to collect money from customers, as opposed to accepting credit or debit cards. For example, many point-of-purchase (POP) systems are starting to use ACH transactions, and similarly, many business-to-business (B2B) and electronic commerce payments are also made over ACH systems.

ACH-based transactions are steadily replacing traditional payment methods based on the writing of physical checks. However, ACH systems are typically not well-suited for real-time credit and debit transactions. An ACH transaction requires that a receiver authorize an originator to issue an ACH debit or credit to an account. The originator must receive a written, verbal, or electronic authorization from the receiver before creating an ACH entry to be given to an originating depository financial institution (ODFI). The ACH entry is then sent to an ACH operator (e.g., the Federal Reserve), and is passed on to the receiving depository financial institution (RDFI), where the receiver's account is issued either a credit or a debit. This transaction protocol imposes a minimum time requirement to process a credit or debit transaction, which typically ranges from at least one to three days.

Many business service customers value the ability to instantly fund checking accounts, debit cards, and other similar accounts. Such customers can use a financial institution that funds their account through either a physical check or ACH transaction, or alternatively, the customer can go into a shop location and receive cash from one of their other accounts, or through a short-term loan or cash advance. The ACH process can take up to three days, and a check can take as long as ten days to clear. For many small transactions (micro-deposits) or transactions that are time sensitive, such time requirements may often be disadvantageous.

Electronic Funds Transfer (EFT) systems have been developed to perform financial transactions electronically for card-based user-initiated debits and credits, electronic payments by businesses, and electronic bill-pay or electronic check clearing, and similar transactions. EFT transactions may be initiated when a payment card is used at an automated teller machine (ATM) or point of sale (POS) terminal, or by telephone or online (Internet) purchases. EFT transactions typically require coordination among a number of parties. A user initiated ATM transaction, for example, is first routed to an acquirer, then through a number of networks to the issuer where the user's account is held. A number of user, account, and transactions authorizations may be needed in the course of a transaction. ATM terminals are typically connected to bank servers through host computers that act as gateways to the cardholders. User provided information, such as PIN and requested cash amount is routed through the host computer to the user's bank computer, and an EFT transaction is used to transfer the funds from the user's bank account to the host processor's bank account. The processor then transfers the user's funds into the ATM merchant's bank account to reimburse the merchant for the ATM withdrawal. In present systems, this settlement transaction is typically accomplished over and ACH network, and thus may take one or more days for settlement. ATM networks and other similar EFT systems thus provide for real-time (instant) disbursal of funds to user, however settlement transactions can take significantly more time.

What is needed, therefore, is a financial transaction system that combines the robustness and security of present ACH-based transaction systems with real-time credit and debit functionality provided by ATM networks for both disbursal and settlement of account-to-account fund transfers and loan fulfillment.

### BRIEF DESCRIPTION OF THE DRAWINGS

Embodiments are illustrated by way of example and not limitation in the figures of the accompanying drawings, in which like references indicate similar elements and in which:

FIG. 1 illustrates a computer network environment that implements one or more embodiments of a financial management system;

FIG. 2A illustrates a network environment in which funds are transferred between various financial institutions using two different payment channels, under an embodiment;

FIG. 2B illustrates a network environment for disbursement of funds under various transaction types using a financial management system server, according to an embodiment;

FIG. 3A illustrates an example of the transactions that may be fulfilled using the system of FIG. 2B;

FIG. 3B is a table that illustrates the real-time debit and credit components for a financial management process, under an embodiment;

FIG. 4 is a block diagram of components and modules of an account-to-account management process executed by the financial management system server, under an embodiment;

FIG. 5A is a flowchart of an example loan funding transaction performed under a financial management system, under an embodiment;

FIG. 5B is a block diagram of a loan funding system, under an embodiment;

FIG. 6 illustrates web page displayed through a user interface for the funding of a loan in a first example;

FIG. 7 illustrates web page displayed through a user interface for the funding of a loan in a second example; and

FIG. 8 illustrates web page displayed through a user interface for the funding of a loan in a third example.

### INCORPORATION BY REFERENCE

The related, co-pending U.S. application Ser. No. 11/584,783 entitled “Multi-Channel Transaction System for Transferring Assets Between Accounts at Different Financial Institutions,” and filed on Oct. 19, 2006 is hereby incorporated in its entirety by reference.

### DETAILED DESCRIPTION

Embodiments of a system for real-time settlements of credit and debit transactions using Electronic Funds Transfer (EFT) networks are described. A financial management system server utilizes an ATM network infrastructure to enable real-time disbursement of loan funds, real-time wire transfers, and instant collection of funds in bill pay systems for vendors. The server processes credits out of an OFDI (Originating Depository Financial Institution) account and transfers in funds to cover the transaction at least as soon as the end of the same business day.

In the following description, numerous specific details are introduced to provide a thorough understanding of, and enabling description for, embodiments of the financial transaction system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

The system and methods described herein execute a transaction involving a withdrawal of assets from a first account at a first financial institution and a deposit of at least a portion of the withdrawn assets to a second account at a second financial institution. The first account and the second account have a common account holder, but may be maintained by different corporate entities. The financial institutions are coupled to one another through different types of networks. The transaction may comprise a standard transaction that is performed at least as a next day transaction, or it may comprise a real-time transaction that is performed immediately upon execution, or any combination thereof. The system utilizes an Automatic Teller Machine network, or similar EFT network to perform the real-time transaction.

As used herein, the terms “account holder”, “customer”, “user”, and “client” are interchangeable. “Account holder” refers to any person having access to an account. A particular account may have multiple account holders, e.g., a joint checking account having husband and wife as account holders or a corporate account identifying several corporate employees as account holders. Various financial account and financial institution examples are provided herein for purposes of explanation. However, it will be appreciated that the system and procedures described herein can be used with any type of asset account and any type of debt account. Example asset accounts include savings accounts, money market accounts, checking accounts (both interest-bearing and non-interest-bearing), certificates of deposit (CDs), mutual funds, bonds, and equities. Example debt accounts include credit card accounts, mortgage accounts, home equity loans, overdraft protection, margin accounts, personal loans, and other types of loans. Example financial institutions include banks, savings and loans, credit unions, mortgage companies, mutual fund companies, lending companies, and stock brokers.

Various attributes or preferences associated with financial transactions or transfers among accounts discussed herein, and include the cost or fees associated with a transaction, the delivery speed or time to complete the transaction, and the risk of failure associated with the transaction. Although particular examples are discussed herein with reference to these specific preferences, it will be appreciated that the methods and systems described herein are applicable to any type of transaction attribute.

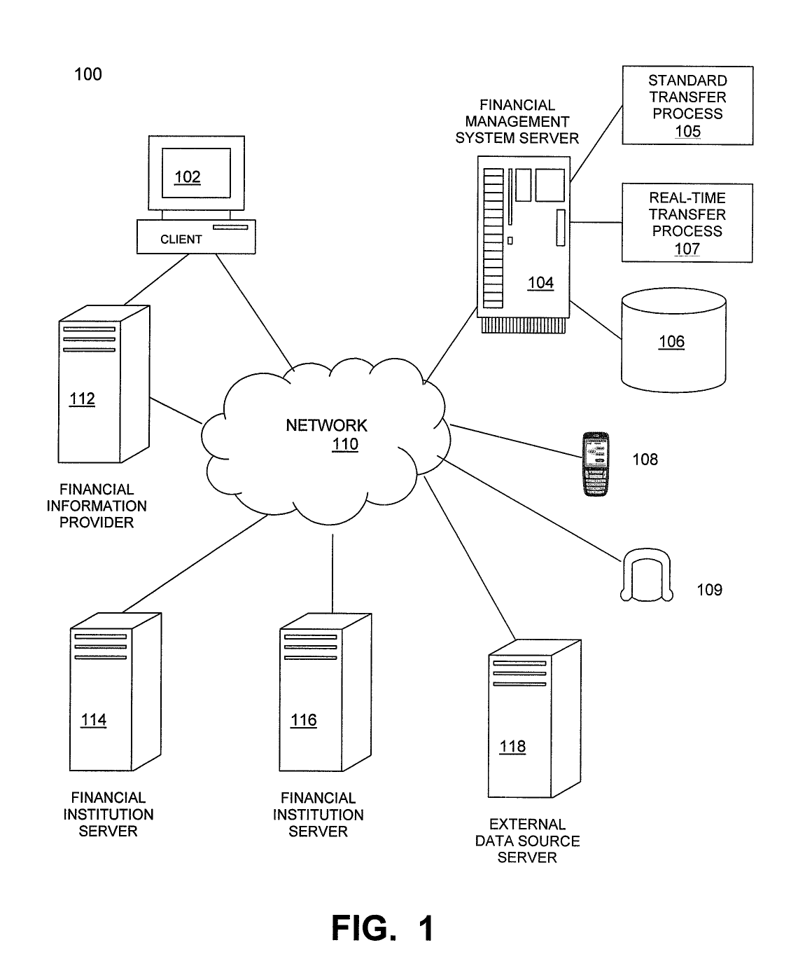

Aspects of the one or more embodiments described herein may be implemented on one or more computers executing software instructions. The computers may be networked in a client-server arrangement, or similar distributed computer network. FIG. 1 illustrates a computer network system 100 that implements one or more embodiments, and in which various servers, computing devices, and financial management systems exchange data across a data communication network. The network environment of FIG. 1 includes multiple financial institution servers 114 and 116 coupled to a data communication network 110. Other server computers, such as an external data source server 118 and financial management system server 104 may also be coupled to network 110. The network environment 100 serves to couple the various server computers to client computers 102 and 108 operated by customers (“users”) of services provided by the entities operating the server computers.

The communication links shown between the network 110 and the various client and server computers shown in FIG. 1 can use any type of communication medium and any communication protocol. For example, one or more of the communication links shown in FIG. 1 may be a wireless link (e.g., a radio frequency (RF) link or a microwave link), such as for client 108, or a wired link accessed via a public telephone system or another communication network, such as for client 102. The network interfaces between the server and client computers to the network 110 may include one or more routers that serve to buffer and route the data transmitted between the server and client computers.

Client computers, such as client 102, may access network 110 in different ways. First, client computer 102 may directly access network 120, for example, by using a modem to access a public telephone network (e.g., a public switched telephone network (PSTN)) that is coupled to network 110. Alternately, client computer 102 may access a separate computer, such as a financial information provider 112, which establishes a connection to network 110. Such a financial information provider 112 may act as a “buffer” between network 110 and client computer 102, or may allow commands and data to simply pass-through between the network 110 and the client computer 102.

Client computers may be any class of computing device, such as personal computer, workstation, and so on. Another class of client computers is represented by mobile client 108. Mobile client (wireless device) 108 can be a mobile computing or communication device, such as a notebook computer, personal digital assistant (PDA), mobile phone, game console, or any similar class of mobile computing device with sufficient processing and communication capability that is capable of communicating with other devices via a wireless connection.

Network 110 may be any type of data communication network using any communication protocol. Further, network 110 may include one or more sub-networks (not shown) which are interconnected with one another. In one embodiment, network 110 comprises the Internet, and may include one or more Wide Area Networks (WAN), Local Area Networks (LAN), or any combination thereof. In the financial transaction context at least a portion of network 110 can be any type of public or proprietary financial network, such as the federal wire system, an ATM (Automated Teller Machine) network, the Federal Automated Clearing House (ACH) network, a debit or credit card network, the Open Financial Exchange (OFX) network, the SWIFT (Society for Worldwide Interbank Financial Telecommunication Network), or any bank proprietary or custom LAN or WAN, or similar type of network.

In one embodiment, one or more of the server computers function as a World-Wide Web (WWW) servers that store data in the form of web pages and transmit these pages as Hypertext Markup Language (HTML) files over the Internet 110 to the client computers 102 and/or 108. For this embodiment, the client computers typically run a web browser program to access the web pages served by server computers and any available content provider or supplemental server. The client computers may thus access the Internet 110 through an Internet Service Provider (ISP).

For the embodiment of FIG. 1, each of the financial institution servers 114 and 116 is associated with a particular financial institution and serves to store data for that financial institution, such as customer account data. The external data source server 118 may represent one or more services that collect and report information regarding current financial market conditions, or other relevant information. Also coupled to network 110 may be a customer service representative or Integrated Voice Response (IVR) system 109 to provide interactive support from a service provider to a user.

The financial management system server can be configured to perform various financial application tasks related to accounts maintained by the user of client computer 102 or 108 at the one or more financial institutions maintaining servers 114 and 116. These include various account analysis functions to determine whether a user's financial accounts (e.g., both asset accounts and debt accounts) are valid, as well as transfer functions that are capable of initiating the automatic transfer of funds between accounts at one or more financial institutions. In standard usage, the financial management system server may be used by a user to transfer funds from a financial institution into his or her savings, checking, or debit card account, or transfer funds from a personal account to a financial institution.

In general, wireless device 108 and client computer 102 allow a user to access information via the network 110. For example, the user can access account information from one of the financial institution servers 114 or 116, access current interest rate data from market information service server 118, or send a request for an analysis of the user's financial accounts to financial management system 104. Financial information provider 112 acts as an intermediary between client computer 102 and other devices coupled to network 110. For example, client computer 102 generates a request for data or account analysis and communicates the request to the financial information provider 112. The financial information provider 112 then retrieves the requested data or initiates the requested account analysis on behalf of the user of client computer 102.

In one embodiment, the network client computer 102 or 108 is configured to run a native or web-based financial application program that allows the user to access and manipulate account information stored on one or more the server computers. This client-side application can comprise one or more standalone programs executed locally on the client computer, or it can be portions of a distributed client application run on the client or a network of client computers.

In one embodiment, system 100 includes a financial management system server 104 executes a standard transaction process 105. The standard transaction process 105 performs various tasks related to financial transfers between accounts held by the financial institutions and accounts held by the client users. These include account ownership verification, standard (two or more days) outbound and inbound transfers, next day outbound and inbound transfers, e-mail confirmations and notifications, and risk management processes. Such a process 105 can be based on transfers utilizing an ACH network, or similar network. The financial management system server 104 also executes a real-time transaction process 107. The real-time transaction process 107 performs various tasks related to financial transfers between accounts held by the financial institutions and accounts held by the client users on a faster time-basis (e.g., less than one day) than the standard transaction process 105. Real-time transaction process 107 performs real-time micro-deposits, real-time PIN-less credit transactions, real-time debit transactions. In one embodiment, the real-time transaction process 107 is based on an ATM (Automatic Teller Machine) network, or a similar network.

As shown in FIG. 1, financial management system server 104 executes one or more server-side financial transfer processes 105 and 107. One or more of these processes may include functional components that perform the tasks of determining the optimum network to perform fund transfers among the financial institution servers, executing the transactions, and providing a single integrated interface to the user of client 102 or 108. Each of the processes 105 and 107 may represent one or more executable programs modules that are stored within financial management system server 104 and executed locally within the server. Alternatively, the server-side processes may be stored on a remote storage 106 or processing device coupled to server 104 or network 110 and accessed by server 104 to be locally executed. In a further alternative embodiment, these processes may be implemented in a plurality of different program modules, each of which may be executed by two or more distributed server computers coupled to each other, or to network 110 separately, or at least partially as client-side processes.

Data for any of the applications contained within or associated with financial applications used by the client computer 102 may be provided by a data store 106 that is closely or loosely coupled to any of the server and/or client computers. Thus, although data store 106 is shown coupled to server 104, it should be noted that content data may be stored in or more data stores coupled to any of the computers of the network, such as client 102 or to devices within the network 110 itself.

Each of the client and server computers shown in FIG. 1 may be embodied on one or more circuits or machines that include at least a central processing unit (CPU) coupled through a bus to various functional units, such as memory, arithmetic/logic blocks, and input/output (I/O) interfaces. The I/O interfaces can be connected directly or indirectly to one or more on-board or off-board peripheral devices, such as disk drives, communication devices, and so on. The CPU can also be coupled to a network controller, which provides access to network 110 through a network port. The computers are programmed using instructions stored at different times in the various computer-readable media.

For purposes of illustration, programs and other executable program components are illustrated herein as discrete blocks, although it is understood that such programs and components reside at various times in different storage components of the computer, and are executed by the computer's processor. For this purpose, the terms “components,” “modules,” “programming blocks,” and so on are used interchangeably to refer to software or firmware programs, or hardware or firmware logic circuits that are configured to execute specific computer-implemented processes. Thus, the systems and procedures described herein can be implemented in hardware or a combination of hardware, software, and/or firmware. For example, one or more application specific integrated circuits (ASICs) can be programmed to carry out the systems and procedures described herein.

In one embodiment, the financial management system server 104 provides an electronic funds transfer (EFT) gateway that facilitates the instant funding of checking accounts, debit cards or stored value cards with proceeds from financial services that are provided to customers, such as check cashing, secure loans or pawn loans, unsecured cash advances or payday loans, cash deposits onto stored value cards, card loyalty programs, and optional guarantee of funds. The EFT gateway of the financial management system server provides access to an interbank network to provide real time funding and payment of an online payday loan (or similar product) using PIN-less credit and debit transactions. The financial management system server leverages the instant access, authentication, and guaranteed fund capabilities of an ATM network to process credits out of a customer's ODFI account and then replenish the funds during a settlement transaction at the end of the day.

The financial management system server is configured to operate with an interbank network that connects ATM or EFT-POS machines of different banks and permits these machines to interact with non-native ATM cards. Present interbank networks include NYCE, STAR, and PULSE, among others. A PIN-less debit or credit is a secure form of payment that allows customers to make or receive payments over the telephone, Internet or via a live agent using their ATM/debit card number, but without entering their personal identification number (PIN) or personal access number (PAN).

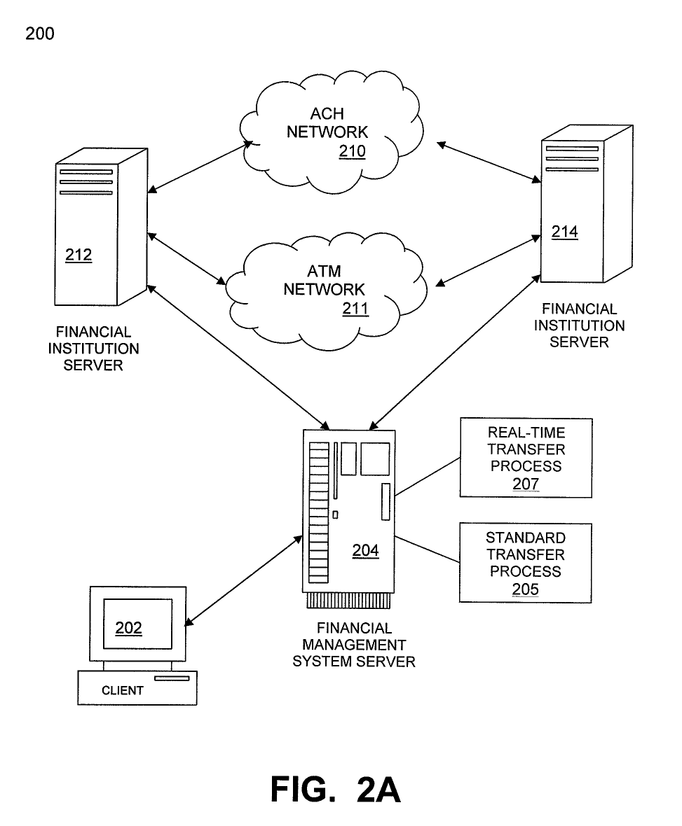

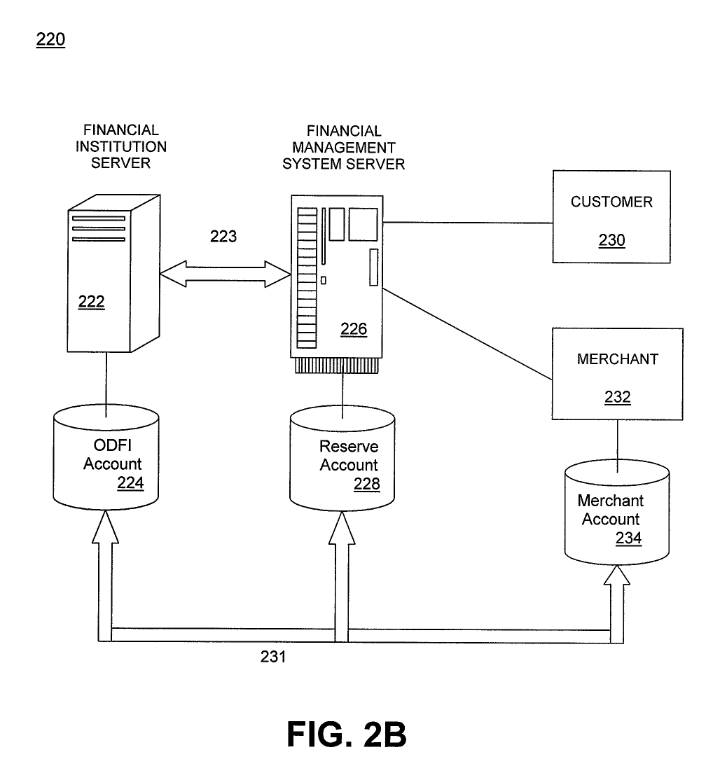

FIG. 2A illustrates an environment 200 in which funds are transferred between various financial institutions using at least two different payment channels, under an embodiment. In this embodiment, a first financial institution 212 is coupled to financial network 214 over two or more payment networks 210 and 211. Other financial institutions (not shown) may also be coupled to the financial institutions over the same payment networks or other different payment networks. For the embodiment of FIG. 2, a financial management system 204 is coupled to both of financial institutions 212 and 214 through either direct links, a separate network, or either or both of network 210 and 211. The financial management system 204 performs account transfers and other account management functions on behalf of a client 202 user who holds accounts at one or both financial institutions 212 and 214.

When an electronic fund transfer (EFT) is required between accounts at the two financial institutions 212 and 214, the financial management system 204 generates a fund transfer instruction based on a request by the user. The fund transfer instruction may include the account information and financial institution information for the accounts involved, the value to be transferred, the speed of the transaction (same day or standard), and other relevant information. The transfer may be a deposit to the user account from a different financial institution account (inbound) or it may be a withdrawal from the user account to the different financial institution account (outbound). In general, a transfer instruction is separated into two different transactions: a first transaction that withdraws the appropriate funds from an account at one financial institution and a second transaction that deposits those funds into an account at the second financial institution. Although two different transactions occur, the fund transfer appears as a single transaction to the user or account holder. Although the two transactions may occur over the same payment network, in some cases, it is either not possible to use a single network or more optimum to use two different networks to accomplish each transaction.

In system 200, two different payment networks or channels 210 and 211 can be used for each of the different transactions between the financial institutions 212 and 214. For standard transactions that can be fulfilled one or more days after initiation, the standard transfer process 205 causes the transfer to be made over a non-real time network 210, which can be an ACH network or similar type of network. For same day transactions, the real-time transfer process 207 causes the transfer to be made over real-time network 211, which can be and ATM network or similar type of network.

The user can maintain different types of accounts at the different financial institutions 212 and 214, such as savings and checking accounts, credit card accounts, CDs or loans, and so on, or the user may maintain an account only at one financial institution, with the other financial institution being used by another party. The use of different networks 210 and 211 allows the transfer of funds between the two financial institutions and among all of the possible accounts held in the two different institutions using the most optimum network with respect to the time sensitivity and transfer speed requirements of the transaction. For example, if the user transfers funds from a checking account in financial institution 212 to a savings account in financial institution 214, the funds may be debited from financial institution 212 using the ACH network 210; and if the user must make a same day loan payment, the funds can be debited from an account and credited to financial institution 214 using the ATM network 211. In one embodiment, the financial management server 204 may include channel selection logic that applies business rules to determine the best network routing scheme for performing the transfer requested by the user in a manner that is transparent to the user and that is in accordance with the transfer speed requirements of the transaction. Alternatively, the user can manually select the appropriate network for each transaction.

The embodiment of system 200 allows a user to transfer funds using standard or real-time channels. This allows a user to fund an account using real-time funding and payment of accounts using PIN-less credit and debit transactions. In one embodiment, the system 200 includes a PIN-less credit capability that powers real-time PIN less deposits in real-time or near real-time, as opposed to the one or two day transaction cycle currently required for micro-deposits. The PIN-less credit capability allows a user to login to their non-host account on a real-time basis to identify the micro-deposit amounts and then return to the account management application to verify the account. The system 200 also includes a PIN-less credit structure that is available through certain interbank networks, such as the STAR and NYCE ATM networks. This enables outbound transfers to occur on a real-time basis as long as the destination account is at a financial institution that supports such a network. The system 200 further supports a real-time PIN-less debit process that is used in many bill payment and intra/inter-institution transfers. This debit process can be used to power both outbound real-time transfers, as well as the debit portion of all outbound transfers. This allows the replacement of traditional ACH transactions that are used to fund standard 3-day and next day transfers, and helps eliminate the NSF risk that would allow for accelerating the total transfer time settlement timeframe and eliminate the risk exposure of next-day transfers.

Various types of transactions can be performed using the financial management system server based network of FIG. 2A. These include loan disbursements from loan providers to customers, inbound and outbound wire-transfers between customers and banks, bill-pay or EFT between customer accounts and vendors, and other similar transactions. In one embodiment, each of these types of transactions using the financial management system server utilizes an ATM or similar type of EFT network to perform the transactions in a real-time manner. FIG. 2B illustrates a network environment for disbursement of funds under various transaction types using a financial management system server, according to an embodiment. Network system 220 of FIG. 2B comprises a financial management system server 226 that controls transactions between a customer 230 who holds an ODFI account 224 at a financial institution 222 and one or more merchants 232 who hold merchant accounts 234. In one embodiment, the financial management system server 226 utilizes an ATM network connection 223 to facilitate real-time settlement of transactions initiated between the customer 230 and the merchant 232. Settlements 231 between the respective accounts are implemented in the form of credit and debit operations to and from the appropriate accounts 224 and 234. In some cases, a reserve account 228 maintained by the financial management system server 226 may be used to fund the transaction or a portion of the transaction.

In one embodiment, the financial management system server 226 includes an automatic routing process that routes the wire transfer, collection or loan funding transaction over one or more appropriate networks based on the network coverage, network availability, and cost of transaction for each leg of the transaction. Network availability includes a determination of the availability of the network for a particular user, while network coverage defines the appropriateness of the network for a class of users or type of transaction. Various networks may impose transfer costs or access fees for certain types of transactions, and these are factored in the determination of transaction cost within the system.

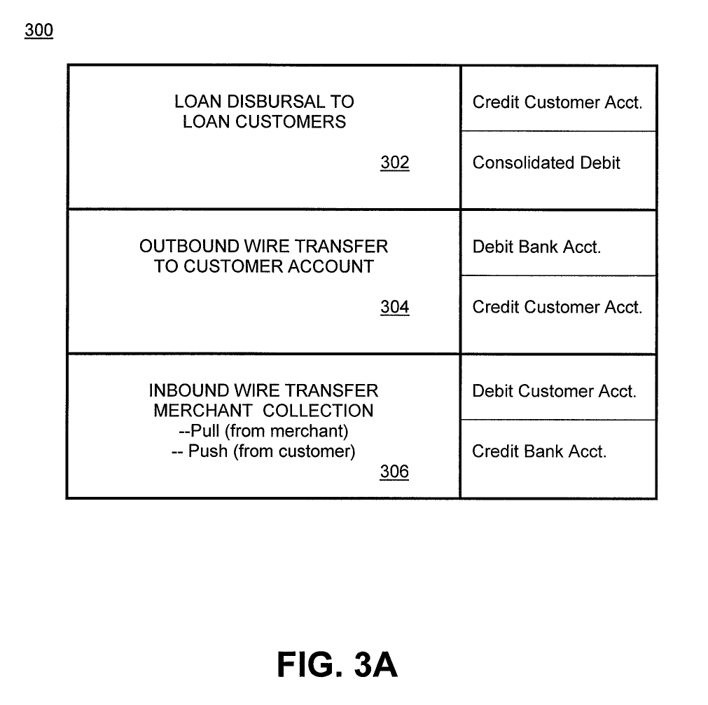

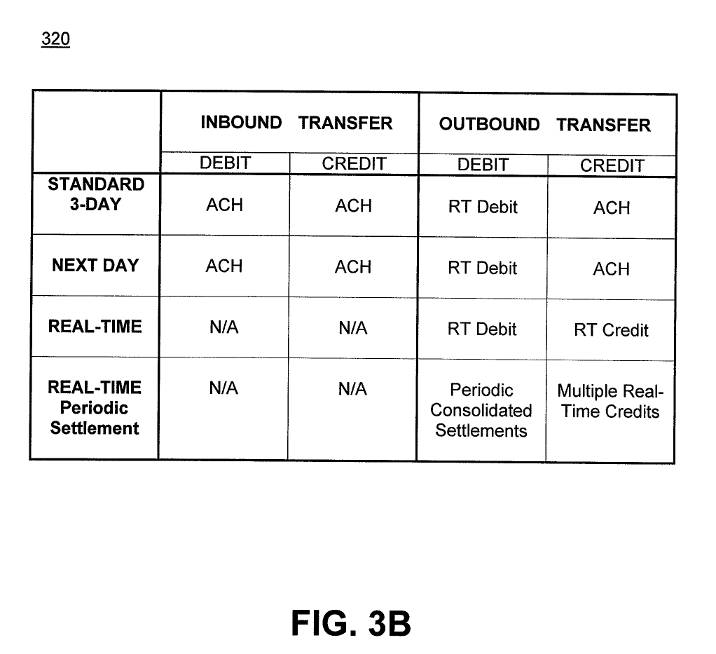

FIG. 3A is a table that lists examples of the transactions that may be fulfilled using the system of FIG. 2B. As shown in FIG. 3A, the system 220 may be used to implement a loan disbursal to loan customers, 302. In this transaction, a loan provider (e.g., merchant 232) provides loan funds to customer 230. The loan funds are first transferred to the user's OFDI account 224 from the merchant account 234. The financial management system server 226 then performs a net settlement at the end of the day (or other specified settlement period) to effectively transfer the funds back into the merchant account 234 for a real time settlement with the lender. These settlement funds may be provided from the reserve account 228 or any similar funds established on behalf of the customer. Transaction 304 is an outbound wire transfer in which merchant funds or bank funds are provided to a customer. In this case, the merchant account 234 is debited and the customer ODFI account 224 is credited in real-time for a virtually instant online wire transaction. Transaction 306 illustrates an inbound wire transfer or bill-pay type of transaction for collections, in which the customer's account is debited and the merchant account is credited. This type of transaction can be initiated by the merchant for a “pull” transaction, or it can be initiated by the user for a “push” transaction. These transactions thus represent the ability of the system 220 to enable the instant disbursement of loans, instant wire transfers, and instant collection of funds for billers. The network effectively leverages the real-time capabilities of the ATM network 211 to enable settlement within one day or less, as compared to present settlement systems, such as those utilizing the ACH network 210.

As shown in table 320, the loan disbursement transactions 302 comprise a credit of the loan funds to the customer account and a consolidated debit; the wire transfer transactions 304 comprise a debit of the funder's account and an associated credit to the customer's account, and the collection transaction 306 comprises a debit of the customer's account and an associated credit to the merchant account 306. The transactions listed in FIG. 3A are representative of example transactions, and many other transactions utilizing the real-time settlement system of FIG. 2B are possible.

FIG. 3B is a table that illustrates the real-time debit and credit components for a financial management process, under an embodiment. Table 320 lists three different types of transfers based on transaction time, standard 3-day, next day, and real-time. Each of these transactions has an inbound transfer and an outbound transfer component that indicates the direction of the transaction relative to a user's account or a financial institution account. Each inbound transfer and outbound transfer leg is further divided into a debit transaction and a credit transaction. Depending on the transaction type, direction, and debit/credit type, the system will utilize either the ACH network 210 or the ATM network 211 of FIG. 2A. As shown in table 320, inbound transfers for the standard and next day transactions are executed over the ACH network, while real-time transactions are not available. For outbound transfers, all debit and real-time credit transactions are executed in real-time over the ATM network, while standard and next day transactions are executed over the ACH network. Such a system can be used to execute time sensitive financial transactions, such as the instant funding of payday loans into customers' accounts using a customer's debit card. In cases where instant funding is not required or where the customer does not have a debit card, funding can be performed using the ACH network. This system can also enable payment of loans via the ACH or ATM networks and facilitate a guaranteed payment outside the ACH queue.

FIG. 3B also illustrates a real-time transaction with periodic settlement. The period for settlement is typically on a daily basis, but can be defined as any appropriate period, such as weekly, monthly, and so on. The debit leg of the outbound transfer comprises periodic consolidated settlements, and the credit leg comprises multiple real-time credits. For this type of transaction, the ATM network 211 is the primary network that is utilized for both the fund disbursal and settlements. The use of such a network effectively reduces the risk associated with real-time transactions. In essence, the safety associated with standard settlement time (e.g., three to four day) transactions is extended to real-time transactions.

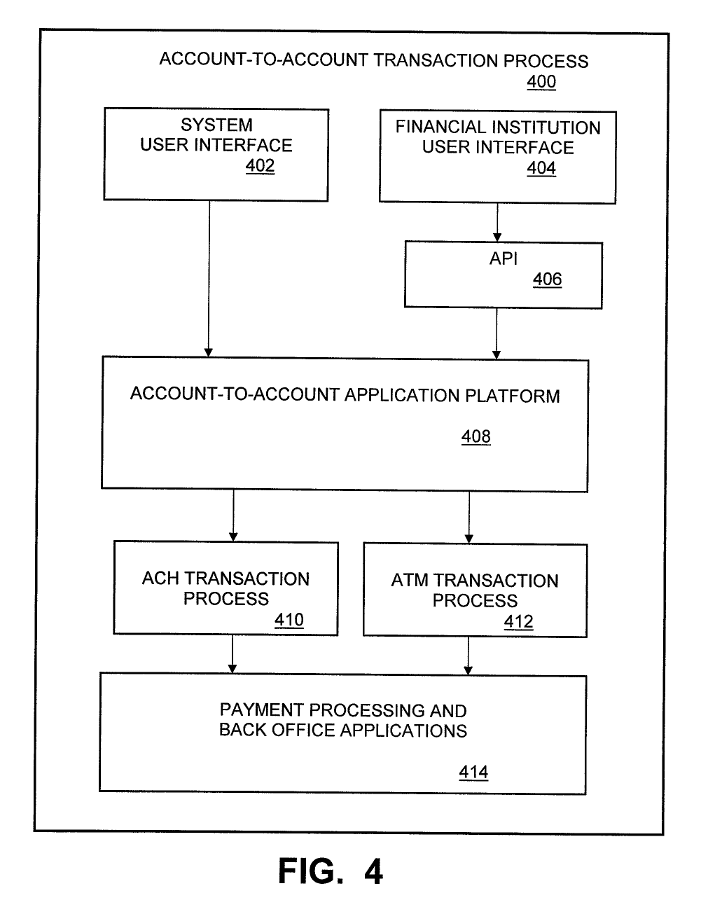

In system 100 of FIG. 1, the financial management system server 104 executes an one or more processes that includes, among other things, a channel selection process that determines or selects the appropriate route to perform the transaction between accounts held at different financial institutions, such as financial institutions 112 and 114, as well as account management processes that allow a user to open different types of accounts, access accounts, access or apply for loans or similar financial products, make payments, and other associated tasks. FIG. 4 is a block diagram of components and modules of an account-to-account management process executed by the financial management system server, under an embodiment. The account-to-account transaction process 300 includes a presentation layer that includes one or more user interface components, such as a system user interface 402 and a financial institution user interface 404. The diagram of FIG. 4 implements the wire transfer transactions 304 illustrated in FIG. 3A. These user interface components allow a user to view and access account information and perform transfer operations. The financial institution user interface 404 represents a user interface that may be provided directly through a web site maintained by the financial institution and may provide direct access to products and resources available to the user through the financial institution website. To interface this user interface to the rest of the system, an application program interface (API) 406 may be provided. The user interface is generally configured to prompt the user for certain information regarding a desired account transaction. Through the user interface, the user is prompted to provide certain information relevant to the transfer. For example, the user must indicate the type of transaction (e.g., money transfer, credit card advance, loan payment, and so on), the identity of the accounts, the amount of money or funds involved, as well as certain preference data, including speed and costs of transaction. The user interface can be implemented in a number of ways that are known to those in the graphical user interface art, such as through the use of drop-down menus, data entry fields, and context sensitive pop-up menus through which the system collects the relevant information required from the user.

In general, any transaction involves a transfer of at least some monetary funds from one account held by the user from a first financial institution into a different account, also held by the user or by another party, but at a second financial institution. The user interface or user interfaces 402 and 404 are functionally coupled directly or indirectly, such as through API 406, to an application layer consisting of an account-to-account application platform 408. The application platform 408 contains one or more application programs that facilitate financial transactions and manage customer accounts. These programs serve to store customer data, such as customer account information, online banking login names and passwords, and user preferences. They also store certain relevant financial institution data for the financial institutions in the network, and any relevant market information. The financial institution data can include, for example, transaction routing data, account offerings, account interest rates, and customer requirements and guidelines, such as minimum account balances, and so on. The market information can include data such as average interest rates for different types of accounts (both asset accounts and debt accounts), the best available interest rates for each type of account, and the financial institutions offering the best available interest rates.

The account-to-account application platform is coupled to a transaction processing layer that includes one or more transaction processing components, such as ACH transaction process 410 and ATM transaction process 412. Depending upon implementation, one or more API components may be used between the application platform 408 and the transaction layer. The transaction processes 410 and 412 constitute communication gateways that allow for communication over one or more network channels. The transaction processes 410 and 412 each include a communication interface that allows the financial management system server 104 to communicate with other computing systems, such as servers, client computers, and portable computing devices. In one embodiment, the communication interface is a network interface to a LAN, which is coupled to another data communication network, such as the Internet.

As shown in FIG. 4, the transaction processes invoke one or more payment processing and/or back office applications 414. Any transaction is essentially a two step process in which, during the first step, funds are pulled from (debited) an account at a first financial institution, and in the second step, the funds or a portion of the funds placed into (credited) to an account at a second financial institution. During the transaction, other processes may have occurred, such as currency exchange, rerouting of certain funds, docking of fees/penalties, or other similar manipulations, however the basic transaction involves simply the withdrawal of money from one account for deposit into a second account. The payment processing applications 414 include modules that process the payments into the second account from the first account and performs the necessary account verifications, reconciliation steps, and any denial and retry steps in the case of a failed transaction. In one embodiment, the backend application 414 comprises a suite of programs that monitor, track and service customers of the financial management system, as well as manage the transactions for funding and paying loans. This backend process provides a user interface that displays summary data for each customer, including transaction, fee, risk, and suspension information. Thus user interface also displays details of each specific transaction, including details on the separate credit and debit legs of the transaction. For this embodiment, the financial transaction typically comprises the funding of a loan applied for by the customer, and the subsequent repayment of the loan, although other similar transactions can also be covered.

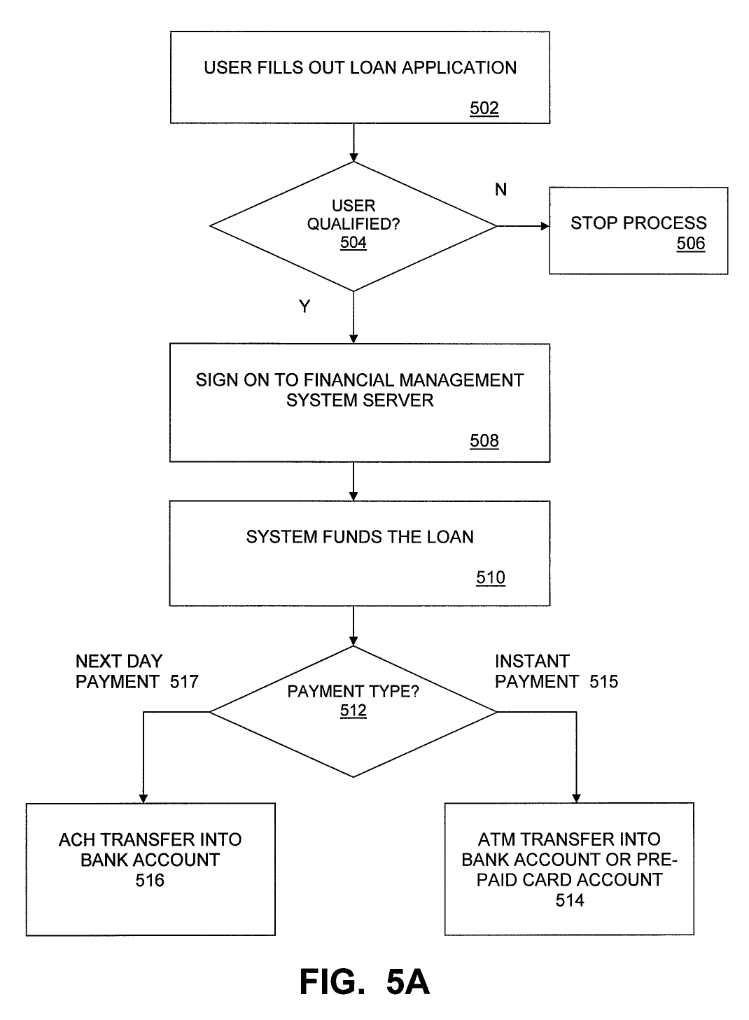

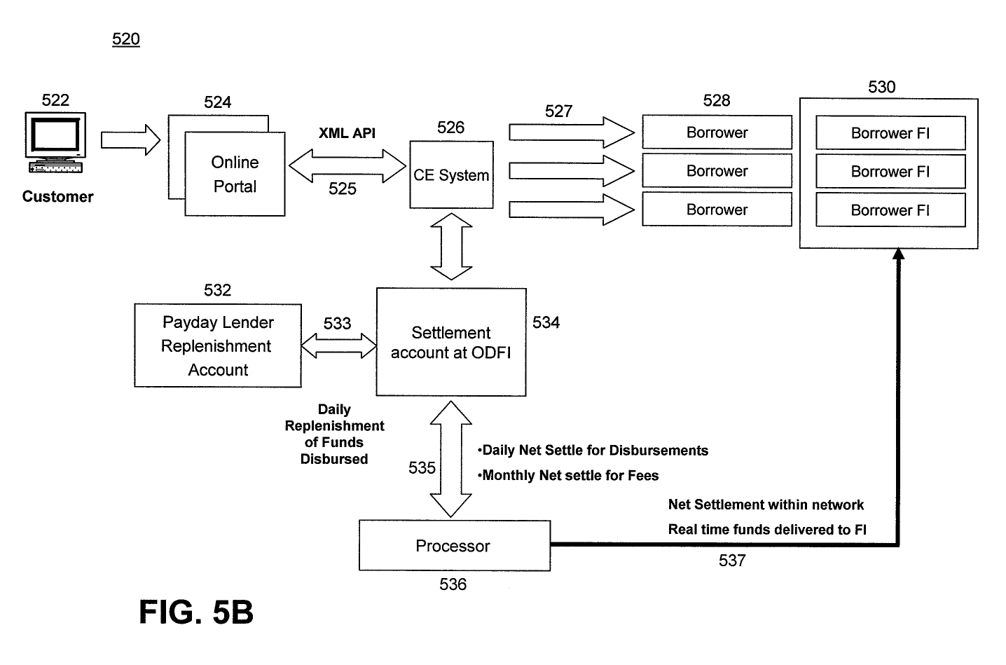

FIG. 5A is a flowchart of an example loan funding transaction 302 performed under a financial management system, under an embodiment. The transaction begins with the user filling out a loan application, block 502, which typically is an online loan application provided by a financial institution directly through their own user interface, or a loan application provided by the financial management system server. Once the loan application is completed, the financial institution or the system determines if the user is qualified for the loan, block 504. If the user is not qualified, the process stops, block 506. If, however, it is determined in block 504 that the user does qualify for the loan, the user is prompted to sign on to the financial management system server. In one embodiment, this is an account-based sign in process in which the user must be subscribed in order to utilize the financial management system services. Once the user has provided a valid account or created a new account, the system funds the loan. In one embodiment, the financial management system server is operated by a company that maintains one or more reserve accounts to directly fund loans applied for by its users. This company may impose its own limits and requirements governing the funding of loans and the provision of financial services to its member users.

In funding the loan, the financial management system server must then transfer funds from a reserve account, or other account into the account specified by the user. In one embodiment, the system includes channel selection logic that determines which channel a particular leg of the transaction should be routed through. For purposes of discussion, the term “channel” refers to a particular network or portion of network, such as network 210 or 211 between the two financial institutions involved in a transfer. As stated above, the possible channels between the two financial institutions could include networks such as ATM, ACH, OFX, credit card, proprietary bank networks, and the like. The channel selection business logic utilizes the information received from the user regarding the transaction type, as well as the user preferences with regard to transaction time, cost, risk, and so on. In certain cases, if time is critical, a faster channel, such as the ATM network 2112 may be selected the by the channel selection business logic, but this may increase the cost of the transaction. However, if the user indicates that cost is not to exceed a certain value, or if the user specifies a longer time to perform the transaction, a less costly channel, such as the ACH network 210 may be utilized instead. The size of the transaction may also dictate which network is used because some networks may have maximum transfer limits. In general each channel or network type (ATM, ACH, OFX, and so on) may dictate a specific set of protocols for messages, payments, and the like. A channel communications rules component executed by the financial management system server can be used to determine the sequence of messages and payments that required for the selected channel. This component also conditions the messages to conform to the protocols and formats required by the different networks. For example, present ACH networks have different message transmission requirement from present ATM networks, therefore a message intended to be transmitted over an ACH network would be packaged differently from a message that performs the same function, but that is transmitted over an ATM network.

Once the messages for a particular leg of the transaction have been properly formulated and formatted for the selected network, a transaction execution module then executes the financial transaction on behalf of the user by implementing the channel communication rules for the selected channel for the present leg of the transaction. The transaction execution module may include submodules, such as a real time transaction manager, a payment processing engine, and a consolidation/authorization module for performing tasks such as consolidating debit/credit to suspense account. Thus, as shown in FIG. 5, after the system funds the loan, it determines which type of payment is requested or required by the user, block 512. If the payment is an instant payment (i.e., less than 24 hours) 515, then the financial system management server performs an ATM transfer into the bank account or pre-paid card account of the user, block 514. If the payment can be made by the next day or longer 516, then the financial system management server performs an ACH transfer into the bank account or pre-paid card account of the user, block 516. The transfer process is intended to be an automated process that performs the fund transfer operation in a manner that is transparent to the user. The user need only specify the type of transaction, transaction amount, account information, and certain preference information. The system then determines the best channel route based on this input.

As shown in FIG. 5A, the system funds the loan 510. FIG. 5B is a block diagram of a loan funding system, under an embodiment. In system 520, a customer 522 access the financial system management server 526 through an online portal 524 over an XML API link 525. The online portal 524 could comprise payday lender web pages that allow a customer to open an account and have loan applications approved. The portal also provides an interface that allows the user to initiate funding transactions and have funds delivered in real time through the network. The financial system management server 526 communicates with the borrower's financial institution 530 via ATM messages over a gateway 528. This gateway allows for debits to the settlement ODFI accounts and credits to the destination. Data over network 520 is transmitted over the link from customer 522 to borrower 528, while the actual funds flow through network defined by the payday lender replenishment account 532 to the settlement account at the ODFI 534. Funds are disbursed on a periodic (e.g., daily) basis over link 533. A daily net settlement for disbursement and a monthly net settlement for fees are performed by processor 536 and real time funds are delivered to the borrower financial institution 530 over link 537.

In one embodiment, the financial management system server utilizes a back-end application that manages the funding of the loan, as well as the payback of the loan. Transaction events can be processed individually or batched and then processed through a suspense account prior to funds transfer to the customer account. The customer account may be a bank account, a pre-paid card account, or any similar type of account. To manage the loan payback, payment events are processed individually or in batches to cause the transfer of funds from the customer bank account into the suspense account. Transaction failures, caused by bad loan payments, can be resent automatically, and can be split to avoid an NSF return. A single database can be used to manage both the loan funding and payback transactions.

For instant transactions that involve payment over the ATM network, the financial management system server can be configured to transmit ATM messages via a gateway. Credit payments are made directly to the user account, or the borrower account in the case of a loan. Debit transactions are processed by settlement to the ODFI account. If a reserve or replenishment account is used to fund loans on behalf of customers, daily replenishment of funds disbursed may be performed, as well as a daily net settlement of disbursements and a monthly net settlement for fees.

In one embodiment, the back-end applications may include other modules to manage the customer accounts and provide account distribution guidance, such as asset and debt analysis and recommendation modules, balance sheet analysis and recommendation modules, report generators, and the like. Any or all of the individual modules illustrated in FIG. 4 can be contained in a single execution domain, or they may be distributed among different execution domains that are executed by the financial management system server 104, either locally or remotely.

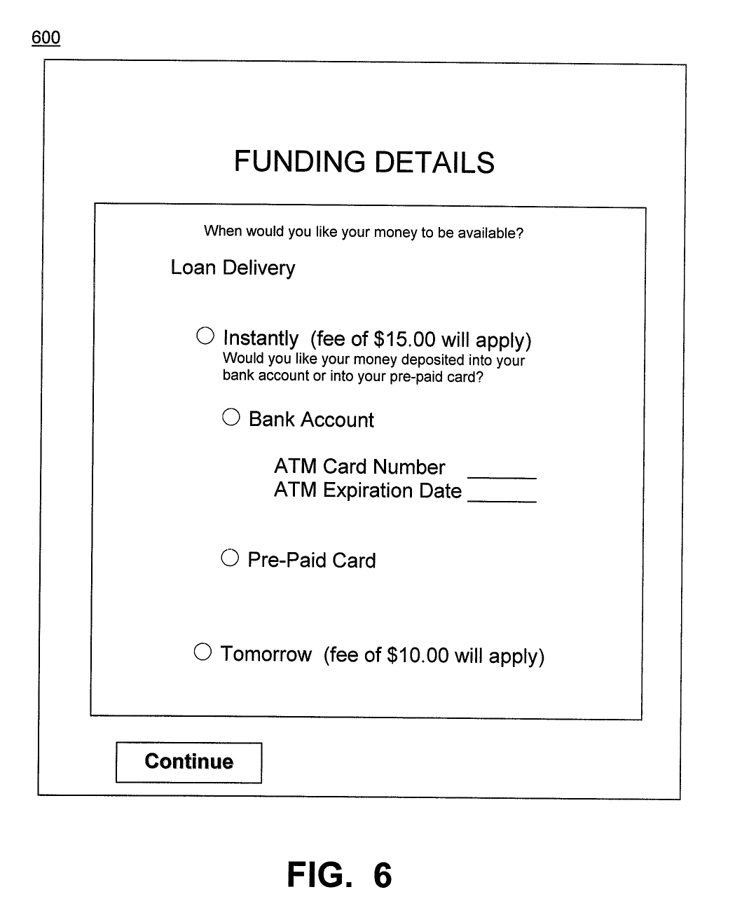

As shown in FIG. 4, the account-to-account transaction process includes one or more user interface modules 402. These user interfaces provide a means by which a user can input relevant financial transaction information into the financial management system server. Various different information, reporting, and input screens are displayed to the user through the user interfaces, which are typically embodied in the form of web pages for embodiments in which network 110 comprises the Internet. FIG. 6 illustrates web page displayed through a user interface for the funding of a loan in a first example. For the example illustrated in FIG. 6, the user is displayed a number of choices to select in accordance with his or her loan funding preference. Thus, on web page 600, the loan delivery section includes two main choices allowing the user to select either instant delivery or next-day delivery. The fee associated with each choice is also selected. In the event the user selects the instant delivery option, further options allowing selection of payment to a bank account or pre-paid card account are displayed. Since the instant transfer to a bank account requires an ATM network 211 transaction, the user must provide a valid ATM card number.

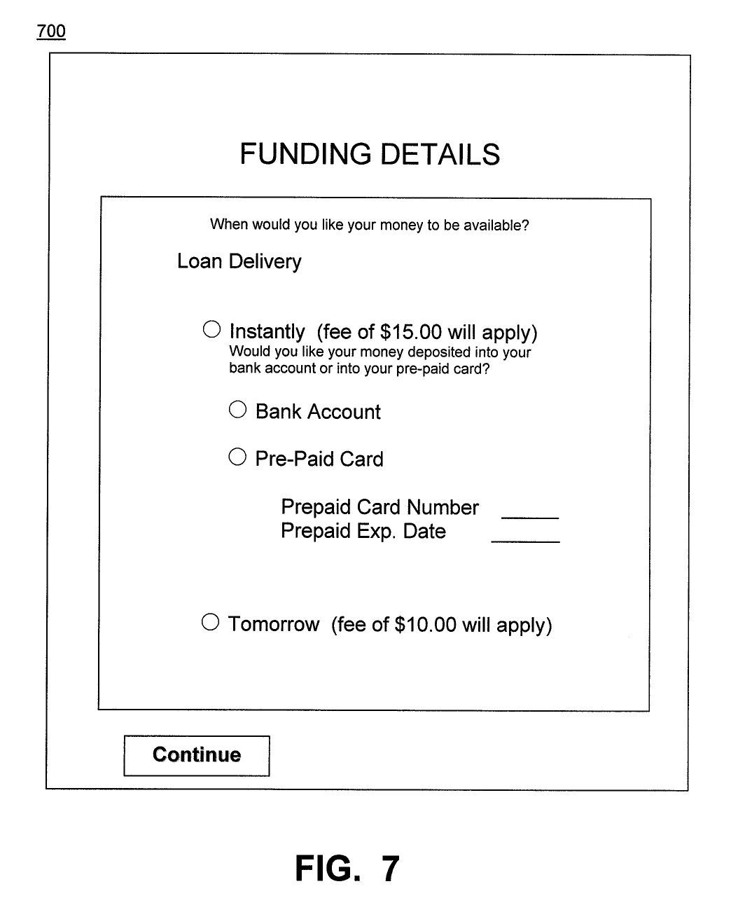

FIG. 7 illustrates web page displayed through a user interface for the funding of a loan in a second example. For the example of FIG. 7, the user has selected an instant payment into a pre-paid card account. In this case, the ATM network 211 is also used, and a pre-paid card number must be provided in order to facilitate use of this network.

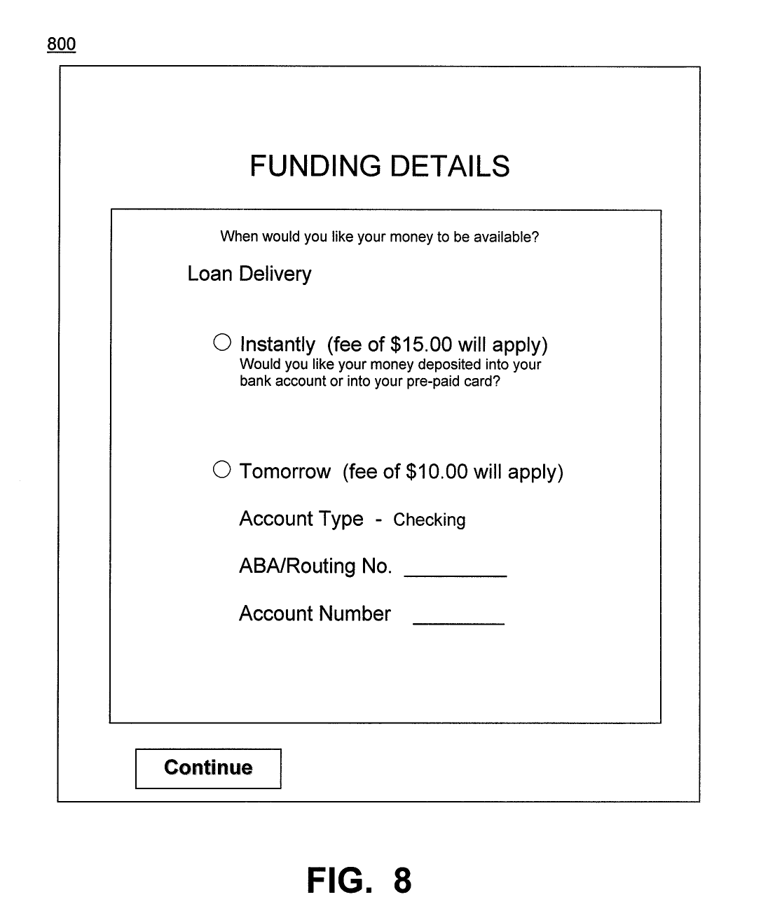

FIG. 8 illustrates web page displayed through a user interface for the funding of a loan in a third example. For the example of FIG. 8, the user has selected the standard, or next day delivery option. In this case, the ACH network 210 is used, and the user is prompted to provide relevant ACH network data. This includes an account type (e.g., checking, savings, money market, etc.), bank routing number, account number, and so on.

Embodiments described herein can be applied to any appropriate financial transaction or financial transfer context. Financial institution customers (both individuals and businesses) typically maintain multiple financial accounts at one or more financial institutions. Financial institutions include, for example, banks, savings and loans, credit unions, mortgage companies, lending companies, and stock brokers. The financial accounts that are maintained may include asset accounts (such as savings accounts, checking accounts, certificates of deposit (CDs), mutual funds, bonds, and equities), and debt accounts (such as credit card accounts, mortgage accounts, home equity loans, overdraft protection, and other types of loans). Although the figures herein generally illustrate a transaction involving two financial institution servers, it should be noted that transactions processed by a financial management system server on behalf of a client may involve any number of accounts held on any number of financial institution servers. In general however, any transaction involving any number of accounts and entities is first decomposed into discrete individual steps involving specific transfers between pairs of accounts.

Embodiments described herein describe a method of performing a financial transaction over a network comprising: receiving a customer request for a wire transfer of funds from a financial institution account to a customer account; debiting the funds from the financial institution account over a first network; crediting the funds to the customer account over a second network; transferring settlement funds to the financial institution account over an electronic funds transfer (EFT) network at the end of a defined settlement period, wherein the settlement period is selected to result in real-time settlement of funds to the first account; and routing the wire transfer transaction based on the network coverage, network availability, and cost of the transaction. At least one of the first network and second network may comprise the EFT network. The EFT network may consist of an Automatic Teller Machine (ATM) network is selected from the group comprising NYCE, PULSE, and STAR networks. In one embodiment, the settlement period is on a daily basis. The method of the embodiment further comprises determining a transaction time requirement for the transfer of funds; transferring the funds over the EFT network if the time requirement for the funds is less than 24 hours; and transferring the funds over an automated clearinghouse (ACH) network if the time requirement for the funds is greater than 24 hours. The settlement funds may be provided by a reserve account maintained by a financial service entity. In one embodiment, the user input is provided through a graphical user interface displayed on a client computer coupled to a first server computer operated by the financial service entity, and a second server computer operated by a financial institution.

In one embodiment, a method of performing a financial collections transaction over a network comprises: receiving a collection request for wire transfer of funds from a customer account to a merchant account; debiting the funds from the customer account over a first network; crediting the funds to the merchant account over a second network; transferring settlement funds to the customer account over an electronic funds transfer (EFT) network at the end of a defined settlement period, wherein the settlement period is selected to result in real-time settlement of funds to the first account; and routing the collection transaction based on the network coverage, network availability, and cost of the transaction. For this embodiment, at least one of the first network and second network may comprise the EFT network, and the EFT network may consist of an Automatic Teller Machine (ATM) network is selected from the group comprising NYCE, PULSE, and STAR networks. The method of this embodiment may further comprise determining a transaction time requirement for the transfer of funds; transferring the funds over the EFT network if the time requirement for the funds is less than 24 hours; and transferring the funds over an automated clearinghouse (ACH) network if the time requirement for the funds is greater than 24 hours. The collection request may be initiated by the customer or by the merchant. The settlement funds may be provided by a reserve account maintained by a financial service entity.

Embodiments may also be directed to a method of performing a loan fulfillment transaction over a network, comprising: receiving a request for disbursement of loan funds from a funder to a customer; crediting the funds to a customer account over a first network; performing a consolidated debit of funds from the funder account over a second network; and transferring settlement funds to the funder account over an electronic funds transfer (EFT) network at the end of a defined settlement period, wherein the settlement period is selected to result in real-time settlement of funds to the first account. For this embodiment, at least one of the first network and second network may comprise the EFT network, and the EFT network may consist of an Automatic Teller Machine (ATM) network is selected from the group comprising NYCE, PULSE, and STAR networks. This method may further comprise routing the loan funding transaction based on the network coverage, network availability, and cost of the transaction. In one embodiment, this method may further comprise: determining a transaction time requirement for the transfer of funds; transferring the funds over the EFT network if the time requirement for the funds is less than 24 hours; and transferring the funds over an automated clearinghouse (ACH) network if the time requirement for the funds is greater than 24 hours. The settlement funds may be provided by a reserve account maintained by a financial service entity.

Embodiments may also be directed to a system comprising: a user interface receiving a user request for transfer of funds from a first account to a second account; a transaction processing engine determining a transaction time requirement for the funds transfer; a channel selection engine selecting a first network for transfer of funds if the funds transfer is a real-time transfer, and selecting a second network for transfer of funds if the funds transfer is a non-real time transfer; a channel communications rule engine configured to conform one or more messages comprising data for the transaction to a message protocol dictated by the first and second networks, respectively; and a settlement engine configured to transfer settlement funds to the first account from a reserve account over an electronic fund transfer (EFT) network at the end of a defined settlement period, wherein the settlement period is selected to result in real-time settlement of funds to the first account. The transfer of funds may be a transaction selected from the group consisting of: loan disbursal, wire transfer to a customer account, and a collection from a customer account, and at least one of the first and second network may comprise the EFT network.

Aspects of the financial management system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the financial management system is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the financial management system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the financial management system are presented below in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of performing a financial transaction over a network comprising:
receiving a customer request for a wire transfer of funds from a financial institution account to a customer account;
debiting the funds from the financial institution account over a first network;
crediting the funds to the customer account over a second network;
transferring settlement funds to the financial institution account over an electronic funds transfer (EFT) network at the end of a defined settlement period, wherein the settlement period is selected to result in real-time settlement of funds to the first account; and
routing the wire transfer transaction based on the network coverage, network availability, and cost of the transaction.

2. The method of claim 1, wherein at least one of the first network and second network comprises the EFT network.

3. The method of claim 2, wherein the EFT network consists of an Automatic Teller Machine (ATM) network is selected from the group comprising NYCE, PULSE, and STAR networks.

4. The method of claim 1, wherein the settlement period is a daily settlement.

5. The method of claim 1, further comprising:
determining a transaction time requirement for the transfer of funds;
transferring the funds over the EFT network if the time requirement for the funds is less than 24 hours; and
transferring the funds over an automated clearinghouse (ACH) network if the time requirement for the funds is greater than 24 hours.

6. The method of claim 1, wherein the settlement funds are provided by a reserve account maintained by a financial service entity.

7. The method of claim 6 wherein the user input is provided through a graphical user interface displayed on a client computer coupled to a first server computer operated by the financial service entity, and a second server computer operated by a financial institution.

8. A method of performing a financial collections transaction over a network comprising:
receiving a collection request for wire transfer of funds from a customer account to a merchant account;
debiting the funds from the customer account over a first network;
crediting the funds to the merchant account over a second network;
transferring settlement funds to the customer account over an electronic funds transfer (EFT) network at the end of a defined settlement period, wherein the settlement period is selected to result in real-time settlement of funds to the first account; and
routing the collection transaction based on the network coverage, network availability, and cost of the transaction.

9. The method of claim 8, wherein at least one of the first network and second network comprises the EFT network.

10. The method of claim 9, wherein the EFT network consists of an Automatic Teller Machine (ATM) network is selected from the group comprising NYCE, PULSE, and STAR networks.

11. The method of claim 8, wherein the settlement period is a daily settlement.

12. The method of claim 8, further comprising:
determining a transaction time requirement for the transfer of funds;
transferring the funds over the EFT network if the time requirement for the funds is less than 24 hours; and
transferring the funds over an automated clearinghouse (ACH) network if the time requirement for the funds is greater than 24 hours.

13. The method of claim 8, wherein the collection request is initiated by the customer.

14. The method of claim 8, wherein the collection request is initiated by the merchant.

15. The method of claim 8, wherein the settlement funds are provided by a reserve account maintained by a financial service entity.

16. A method of performing a loan fulfillment transaction over a network, comprising:
receiving a request for disbursement of loan funds from a funder to a customer;
crediting the funds to a customer account over a first network;
performing a consolidated debit of funds from the funder account over a second network; and
transferring settlement funds to the funder account over an electronic funds transfer (EFT) network at the end of a defined settlement period, wherein the settlement period is selected to result in real-time settlement of funds to the first account.

17. The method of claim 16, wherein at least one of the first network and second network comprises the EFT network.

18. The method of claim 17, wherein the EFT network consists of an Automatic Teller Machine (ATM) network is selected from the group comprising NYCE, PULSE, and STAR networks.

19. The method of claim 16 further comprising routing the loan funding transaction based on the network coverage, network availability, and cost of the transaction.

20. The method of claim 16, wherein the settlement period is a daily settlement.

21. The method of claim 16, further comprising:
determining a transaction time requirement for the transfer of funds;
transferring the funds over the EFT network if the time requirement for the funds is less than 24 hours; and
transferring the funds over an automated clearinghouse (ACH) network if the time requirement for the funds is greater than 24 hours.

22. The method of claim 16, wherein the settlement funds are provided by a reserve account maintained by a financial service entity.

23. A system comprising:
a user interface receiving a user request for transfer of funds from a first account to a second account;
a transaction processing engine determining a transaction time requirement for the funds transfer;
a channel selection engine selecting a first network for transfer of funds if the funds transfer is a real-time transfer, and selecting a second network for transfer of funds if the funds transfer is a non-real time transfer;
a channel communications rule engine configured to conform one or more messages comprising data for the transaction to a message protocol dictated by the first and second networks, respectively; and
a settlement engine configured to transfer settlement funds to the first account from a reserve account over an electronic fund transfer (EFT) network at the end of a defined settlement period, wherein the settlement period is selected to result in real-time settlement of funds to the first account.

24. The system of claim 23, wherein transfer of funds is a transaction selected from the group consisting of: loan disbursal, wire transfer to a customer account, and a collection from a customer account.

25. The system of claim 24, wherein at least one of the first second network comprises the EFT network.
